(19) United States
(12) Patent Application Publication
(10) Pub. No.: US 2014/0076730 A1
(43) Pub. Date: Mar. 20, 2014

(54) METHOD AND APPARATUS FOR EXTRACTING ENERGY AND METAL FROM SEAWATER ELECTRODES

(71) Applicant: Indiana University Research and Technology Corporation, (US)

(72) Inventors: Youngsik Kim, Fishers, IN (US); Nina Mahootcheian Asl, Indianapolis, IN (US)

(21) Appl. No.: 13/783,987

(22) Filed: Mar. 4, 2013

Related U.S. Application Data
(60) Provisional application No. 61/715,530, filed on Oct. 18, 2012.
(60) Provisional application No. 61/683,915, filed on Aug. 16, 2012.
(60) Provisional application No. 61/606,465, filed on Mar. 4, 2012.

(51) Int. Cl. H01M 8/18; C25C 1/02; C25C 7/04; C25C 7/00

(52) U.S. Cl. CPC H01M 8/188; C25C 7/007; C25C 1/02; C25C 7/04
USPC 205/99; 204/251; 205/261; 205/343

(57) ABSTRACT

A method of harvesting Group I metals from waste materials, including agitating Group I metal-containing materials in water to define a Group I metal-rich aqueous solution, removing any solid material from the Group I metal-rich aqueous solution, and filling the cathode portion of an electrochemical cell with the Group I metal-rich aqueous solution. A current collector is introduced into the Group I metal-rich aqueous solution, a steel electrode is operationally connected to the cathode portion, and the cathode portion is operated to deposite Group I metal onto the steel electrode.

### CROSS REFERENCE TO RELATED APPLICATIONS

This application claims priority to co-pending U.S. provisional patent applications Nos. 61/715,530, filed on Oct. 18, 2012; 61/683, 915, filed on Aug. 16, 2012; and 61/606,465, filed on Mar. 4, 2012, each of which are incorporated herein in their entirety.

### TECHNICAL FIELD

The present invention relates generally to the field of electrochemistry, and, more particularly, to electrochemical techniques for energy generation and for mining and recovering Group I metal.

### BACKGROUND

The increased interest in using renewable energy such as solar and wind has prompted the need to find energy storage systems to make such energy sources reliable. Many types of energy storage systems have been investigated, such as pumped hydroelectric storage, compressed air energy storage (CAES), flywheels and electrochemical storage. Depending on the application of the system, each design is comparably more suitable either in efficiency, lifetime, discharge time, and weight or mobility of the system. Among these various energy storage systems, electrochemical storage such as batteries have the advantage of being more efficient compared to pumped hydroelectric and CAES storage. A battery works by directly converting chemical energy to electrical energy by employing different chemistries. A varied combination of anode, cathode, and electrolyte materials produces numerous types of batteries such as the Li-ion, Lead-acid, Na—S, and vanadium redox batteries.

Presently, Group I metal, in particular lithium (Li)-ion, rechargeable batteries are the most common type of battery used in consumer portable electronics due to this type of battery's high energy density per weight or volume and its good recharge efficiency. However, the Li-ion battery for use in stationary energy storage applications is limited by lithium availability, cost, and safety issues. The most inexpensive rechargeable batteries are lead-acid batteries, with efficiency typically between 75-85% and with a 15-25% loss of DC electric current from recharge to discharge. Sodium-sulfur (NaS) batteries are not commonly known, but they have high energy density and efficiency around 76%. However, the NaS batteries are not feasible for portable electric devices because they do not come in smaller sizes and have a high heat requirement. However, the NaS batteries are economical and efficient for larger installations. Another type of rechargeable battery for stationary energy storage applications is the flow battery. It stores electrolytes in tanks; therefore having a flexible energy capacity depending on how many electrolyte tanks one connects to the power input/output unit. The most well-known and widely applied flow battery is the vanadium redox battery (VRB).

Even though the efficiency of the battery is relatively better than other energy storage devices, current battery technology is still considered too expensive for stationary storage. For renewable energy to be stored without government subsid, the storage process must be kept below $200 per kilowatt. Thus, to meet the increasing demand to store large amounts of electric energy for stationary applications one must develop a viable battery technology that, as the battery increases in size, it decreases in cost per unit energy and amount of power stored.

Thus, needs remain for an improved Group I-based battery and an improved means for mining, collecting and recovering Group I metal. The present novel technology addresses these needs.

### DESCRIPTION OF THE DRAWINGS

FIG. 1 is a schematic diagram of a Li-Liquid flow battery system according to a first embodiment of the present novel technology.

FIG. 2 schematically illustrates voltage vs. capacity of various electrode materials.

FIG. 3 graphically illustrates electrochemical potentials of various multi-layer electrolyte configurations.

FIG. 4 is a schematic diagram of a Group I metal-liquid flow battery system according to a second embodiment of the present novel technology.

FIG. 5 is illustrates the process flow for reclamation of Group I metals according to the embodiments of FIGS. 1 and 4.

FIG. 6 is a schematic diagram of a Li-Liquid flow battery system according to FIG. 1 using a NaCl aqueous cathode.

FIG. 7 graphically illustrates charge voltage curve for a Li-liquid solution.

FIG. 8A illustrates discharge voltage curves for various solutions.

FIG. 8B illustrates charge and discharge curves for Cu(ClO₄)₂.

FIG. 9 is a schematic diagram of a seawater-sodium-seawater flow battery system according to a third embodiment of the present novel technology.

FIG. 10 is a schematic diagram of a sodium-liquid flow battery system according to a fourth embodiment of the present novel technology.

### DETAILED DESCRIPTION

For the purposes of promoting an understanding of the principles of the novel technology, reference will now be made to the embodiments illustrated in the drawings and specific language are used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

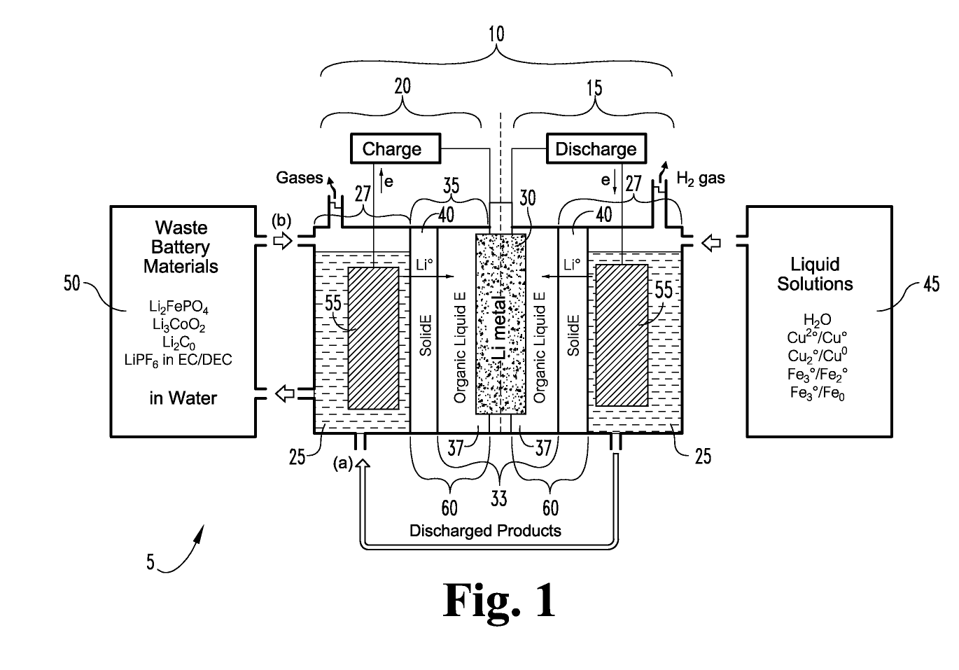

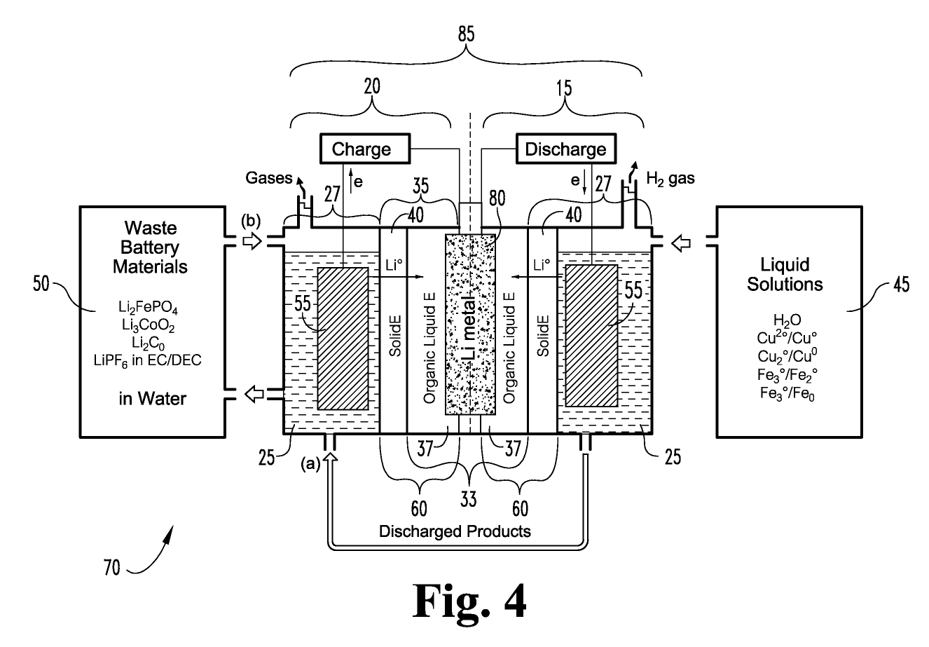

FIGS. 1-4 illustrate a first embodiment of the present novel technology, a Li-Liquid flow battery 10 for a large energy storage system 5 where the discharge portion 15 and charge portion 20 are separated to allow for materials to efficiently store and produce energy. In the discharging system, water and other liquid solutions containing aqueous, non-aqueous, and/or mixed solvents 45 may be used as a cathode 25. Group I metals, such as Na or Li, may be used as an anode 30. For simplicity, the Group I metal Li is used as the example hereinbelow, but it is understood that the discussion generally relates to any Group I metal and is not necessarily restricted to Li. For the charging system 10, sourcing for the Li may include using the discharged products such as LiOH (aq) created by discharging the battery 10, using waste Li-ion battery materials 50 containing Li ions such as the graphite anode 80 LiₓC₆, cathodes 25 made of LiₓFePO₄ or LiₓCoO₂, or the organic liquid electrolyte 35, 1M LiPF6 in EC:DEC, or collecting Li from both sources simultaneously.

The Li metal may be harvested from the waste Li-ion battery material 50, and the harvested Li metal may be discharged with the use of water as cathode 25 to produce electric energy.

In one embodiment, a Lithium ribbon of 99.9% purity and 0.38 mm thick is obtained, and disks of 0.8 cm diameter are cut from the ribbon for use as anodes 30. 1M LiPF6 in ethylene carbonate (EC): dimethyl carbonate (DMC) (1:1 volume ratio) is prepared for use as an organic non-aqueous liquid electrolyte 35. As a solid electrolyte 40, Li-ion conducting Glass Ceramic (LiGC) plate of composition Li1.3Ti1.7A10.3(PO4)3 is prepared measuring 1 inch×1 inch with a 150 μm thickness and a σLi≈10-4 S/cm at room temperature. Solid electrode powders of compositions LiFePO4, LiCoO2, and C6 are prepared. Carbon black may be used as the electronic conductive powders for the solid and liquid electrodes 25, 30. Carbon paper 55 with 280 μm thickness is used as the current collector for liquid solutions.

Referring to FIG. 1, a schematic diagram of a battery cell 10 for use with a small amount (≦5 mL) of liquids as cathodes 25 is shown. In order to prevent the two liquids from mixing, an open side of the polypropylene bar containing the Li metal anode 30 and liquid electrolyte 35 such as 1M LiPF6 in EC:DEC or the like is sealed from the respective cathode compartments 27 by a dense ceramic solid electrolyte 40.

In one embodiment, the solid electrolyte plate 40 is first placed on the top of the anode portion 33 of the cell 10 and sealed, such as by epoxy. The sealing of the anode portion 33 by the solid electrolyte 40 is done to protect the Li metal anode 30 from exposure to a highly oxidizing cathode environment.

The sealed anode portion 33 is placed in a non-oxidizing environment, such as an argon-filled glove box where the water and oxygen concentrations are maintained at low levels, typically less than 4 ppm. The Li metal disk 30 and a non-aqueous electrolyte 35, 1 M LiPF6 in EC:DMC, are loaded into the anode portion 33 under the non-oxidizing atmosphere. After assembling the anode portion 33, the assemblage 33 is moved out of the non-oxidizing environment and liquid cathode 25 is poured into the cathode portion 27 of the cell 10. Then, the carbon paper 55 is placed over the liquid 25. The assembled battery cell 10 is then connected to a testing station (not shown) for charge and discharge tests.

One advantage of the cell 10 is the use of a multi-layer electrolyte 60. The multi-layer electrolyte 60 consists of one liquid electrolyte 35 and one solid electrolyte 40. In one embodiment, the liquid electrolyte 35 may be an organic liquid that is used for the close physical contact it provides with the solid lithium anode 30. The solid electrolyte 40 may be inorganic solid that separates the liquid electrolyte and the liquid cathode and prevents mixing of the liquids while also making it possible to use the cathode 25 in solid, liquid, and gas phases. For example, the solid electrolyte 40 may be of the composition Li₁.3Ti₁.7Al₀.3(PO₄)₃ with an area of 1 inch×1 inch, 150 μm thickness, and σLi≈10⁻⁴ S/cm at room temperature. The relatively low lithium ion conductivity of the solid electrolyte 40 can limit the electrochemical performance of the liquid cathodes 25 when a high current discharge or charge is applied. Hence, a relatively low current rate of about 0.1 mA/cm² is typically applied to minimize the effect of the cell resistance on the voltage of materials being investigated.

By using a solid electrolyte 40 with a lower Highest Occupied Molecular Orbital (HOMO) in the cathode side 25, there is greater flexibility in cathode selection for production of voltages above 4.5 V. This is an improvement over the small electrochemical window of liquid electrolytes, which are presently used and cannot produce a range beyond 1.0-4.5 V vs. Li⁺/Li⁰. In addition, when the anode part 30 of the cell 10 composed of Li metal and the organic liquid electrolyte 35 are completely separated and sealed by the dense solid electrolyte 40 that only provide a Li-ion mobility, the choices for cathode 25 are dramatically widened to include solid, liquid, and gas phases. Applying this concept, gas and liquid phases have been used as cathodes 25 to create different battery systems 5 such as the Li-air, Li-sea water, and Li-aqueous liquid batteries. By charging the cell 10, Li metal may be electrochemically collected from any material containing Li-ions. This extended to harvesting Li metal from waste Li-ion batteries, in both solid and liquid phases, that contain Li ions such as the LiₓC₆ anode 80, LiₓFePO₄ cathode 25, and LiPF₆ in the EC:DEC electrolyte 35. The harvested Li metal may then be an energy source for Li-Liquid flow batteries 10 by using water as the cathode 25. Further, this process may be generalized into harvesting lithium from other sources currently untenable for lithium harvesting such as seawater.

In one embodiment, Li-ions are extracted from lithium solid and liquid phase compounds that are placed in water during charging of the cell 10. Water is selected as a liquid matrix in which the lithium phases are placed and/or dissolved and delivered into the charge section of the Li-Liquid flow battery system 10. Water is chosen as the liquid medium because it is a non-pollutant, abundant, and relatively inexpensive.

Solid cathode particles including LiFePO₄ and LiCoO₂ are mixed with carbon black powder and the mixture is placed in water and ultrasonicated for one hour to produce a homogenous mixture. Then, the homogeneous mixture is placed on carbon paper 55 in the cathode portion, where the carbon paper absorbs the solution and is used it as the current collector 55. In the anode side 33 there is no Li metal attached at the initial state of the cell 10. Stainless steel (SS) is used as a negative electrode at the initial state. The open circuit voltage was observed to be around 0.4 V and 0.8 V vs. stainless steel (SS) electrode for the LiFePO₄ and LiCoO₂, respectively. When the cell 10 began to charge at 0.1 mA/cm², the slope curve is observed to start at its initial state around 0.4-3.5 V. This slope is likely a result of the activation polarization that arises from kinetics hindrances of charge-transfer reaction that takes place at the cathode/electrolyte interface (Li-ions leaving from the cathode particles) and the anode/electrolyte interface (Li forming on the SS electrode).

At 3.5 V after the slope curve, a flat charge voltage appears for the LiFePO₄ cathode 25 which is similar in voltage range to that measured in a coin cell 10 battery configuration with a Li metal anode 30 and an organic liquid electrolyte 35. For the LiCoO₂ cathode 25, the slope curve is observed at the higher voltage range of over 2.5 V, correlating to the Li extraction from the LiCoO₂ cathode 25. The Li extraction from LiCoO₂ and LiFePO₄ in aqueous electrolytes 35 is expected. Typically, Standard Hydrogen Electrode (SHE) and LiTi₂(PO₄)₃ electrodes are used, respectively, for the LiCoO₂ and LiFePO₄ cathodes 25 due to the small electrochemical window of aqueous electrolytes 35.

In one embodiment, a waste Li-ion battery 10 contains a lithiated graphite anode 30, which may be a potential Li-ion source for the Li metal harvesting system 70. The lithiated graphite anode 80 is prepared by insertion of Li-ions into the graphite electrochemically in the cell 85 that uses Li metal as the negative electrode 30. When collecting lithiated graphite from the discharged cell 85 the Li-ions transfer into water. The aggressive reaction with exothermal heat is observed; similar to that of Li metal in the water. The lithiated graphite is a chemical reducing agent. It is noted that the Fermi energy of the lithiated graphite (LiC₆) is only 0.2 eV below the Fermi energy of Li metal. Lithium hydroxide may be formed by the reaction of LiC₆ in water:

LiC₆(s)+H₂O(l).LiOH(aq)+HC₆(s)

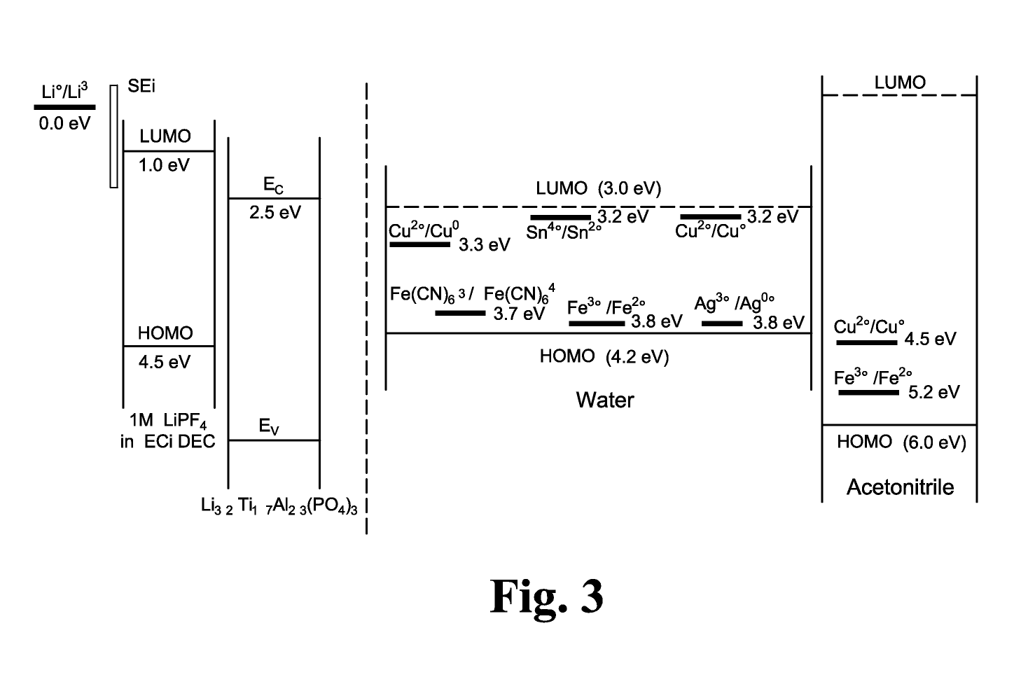

In addition to the anode 30 and cathode 25 materials, electrolytes 35 are likely another Li-ion source for the Li metal harvesting system 70. An organic liquid electrolyte 35 of 1M LiPF₆ in EC:DMC was mixed with water in a volume ratio of 1:1. Carbon black powder was added into the liquid solution. Pure organic liquid electrolytes 35 containing LiPF₆ and carbonate solvent decompose when they are exposed to water leading to the formation LiF, HF, POF₃, LiOH, and other organic compositions. The mixed liquid solution may be charged at 0.1 mA/cm². FIG. 3B shows the charge voltage curve of this liquid solution at 3.2 V vs. Li⁺/Li⁰. This voltage is quite low compared with the oxidation voltage (>4.5 V vs. Li⁺/Li⁰) of the pure organic liquid electrolyte 35 reported in the literature and even lower than the oxidation voltage of 0.1M LiOH (aq) (4.0 V vs. vs. Li⁺/Li⁰) measured in this work. Li-ions in liquid solutions may be collected electrochemically by charging the system even though lithium compounds may undergo changes in their chemical compositions and phases in the presence of water.

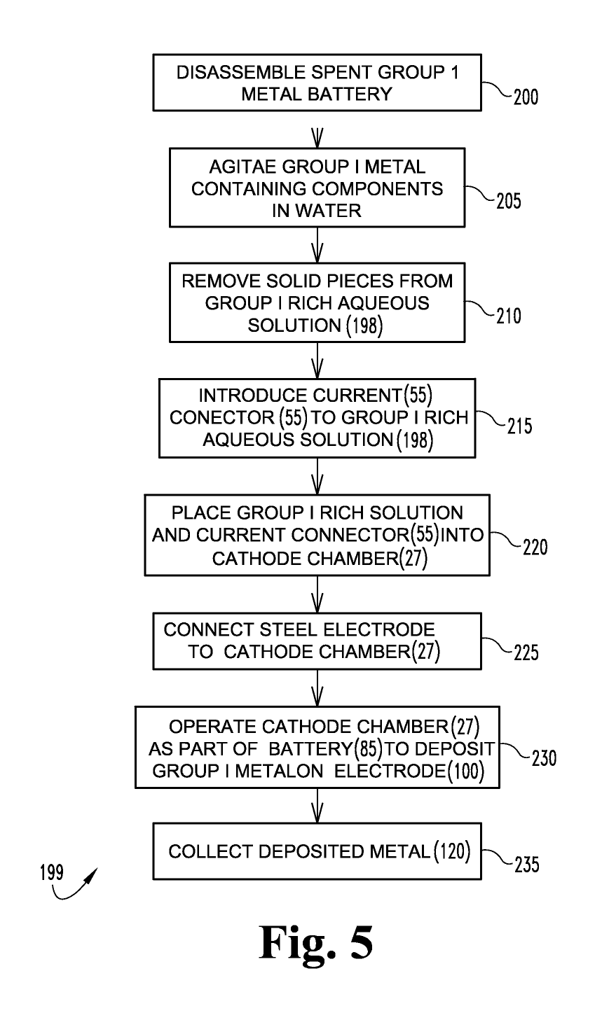

In one embodiment, a system 70 for harvesting Group I metal, in this example lithium from waste Li-ion materials 50 from batteries or the like is discussed. As shown in FIG. 5, the system 70 operates to collect Li metal from a Li-ion batteries via a cell 85 including a graphite anode 80, LiFePO₄ cathode 25, and organic liquid electrolytes 35. FIG. 5 illustrates a process flow 199 for harvesting Group I metal from waste materials. A spent Li-ion battery is disassembled 200, and the entirety of the disassembled battery, including the anode 30, cathode 25, polymer separator, and organic liquid electrolytes 35 is placed in water and agitated 205, such as by stirring, ultrasonication, or the like. After agitation 205 electrode powders 195 and electrolytes 196 containing Li ions are collected. After removing solid pieces, such as the current collector 55, only the liquid solution 198 containing electrode powders 195 and the liquid electrolyte 196 remains. The liquid solution 198 may then be introduced 215 to fresh current collector 55, such as carbon paper. The Group I rich solution 198 and the current collector 55 are loaded 220 into the cathode portion 27 of an electrochemical cell 10 and connected to 225 a bare stainless steel (SS) electrode 100 instead of using a Li metal electrode. The cell 10 is then operated 230 normally and Group I metal (lithium) is deposited onto the electrode 100 for collection 235.

Lithium metal may be observed on the surface of the SS electrode 100 after disassembling the cell 85. The aggressive reaction producing exothermal heat is observed when the SS electrode 100 is placed in the water, which is an additional confirmation of the formation of Group I metal.

Also confirming the formation of Li metal on the SS electrode 100 the charged cell 85 which collects Li metal from waste battery materials 50 is discharged when pure DI water is used as the cathode 25. The mean discharge voltage appears to be about 2.7 V vs. Li⁺/Li⁰ at 0.1 mA/cm² and is similar to the voltage found when fresh Li metal is used in the cell. The following chemical reaction occurs during discharge of the Li-water cell:

2Li(s)+2H₂O(l).2LiOH(aq)+H₂(g)

The discharged products are LiOH dissolved in water and H₂ gas. The LiOH (aq) can be used as the cathode 25. In this example the 0.1M LiOH liquid solution was charged at 4.0 V vs. Li⁺/Li⁰. However, a high concentration (>1M) of LiOH (aq) can damage the surface of the solid electrolyte due to its strong basic character.

In another embodiment, given the Li-liquid flow battery system 5 of FIG. 1, the discharged product of LiOH (aq) may flow into the charge section 20 of the battery system 5 and can be charged to recycle the Li ions contained therein. In this way the concentration of LiOH can be kept low during discharge and charge of the cell 10 by circulating the liquid solution 110.

The electrochemical performances of the Li-liquid flow battery 10 including discharge-charge voltage, voltage efficiency, and rate capability may be improved by increasing the powder 115 carbon black with 62 m²/g of the specific BET surface area is used in this example, but other carbon powders with different sizes and physical properties may be used. Since functionalized carbon powders have a good dispersion character in water, this approach may improve the charge efficiency of the battery by providing better electronic conductivity between waste materials in water. Li-ion conductivity in the liquid solution 110 may also be improved by adding lithium salts such as LiNO₃, LiClO₄, and Li₂SO₄. The addition of more waste organic liquid electrolyte 35 may be another good strategy for improving the Li-ion conductivity in the liquid solution 110 because it contains lithium salts such as LiPF₆ or LiBF₄.

By using a multi-layer electrolyte strategy, various liquid solutions 110 can be discharged and charged with Li metal anode 30. The voltage versus Li metal of the liquid solutions 110 may be tuned by selection of solvent, solute, redox couples, and counter anions. Li metal may be harvested by charging the liquid solutions 110 that contain waste Li-ion battery 85.

The Li-ion battery system 5 has a number of variables, including the voltage behavior of aqueous, non-aqueous, and the mixture of aqueous and non-aqueous liquid solutions, the voltage dependence on selected solvent, solute, redox couples, and counter anions, the effect of the chemistry of the liquid solutions on voltage, and the like.

### Solid Electrolyte and Voltage Dependence in Lithium Liquid Solution

The use of solid electrolytes 40 allows the use gaseous and liquid phases as cathodes for Li batteries, as in the example of the Li-Air and Li-Sea water batteries. Using this solid electrolyte strategy, Fe³⁺/Fe²⁺ and Fe(CN)₆³⁻/Fe(CN)₆⁴⁻ redox couples in an aqueous solution produce 3.8 V and 3.4 V, respectively, vs. Li⁺/Li⁰, when used as cathodes for Li rechargeable batteries. This work also indicates that many possible redox couples in aqueous solutions such as Sn⁴⁺/Sn²⁺, Cu2⁺/Cu⁰, SnCl₆²⁻/SnCl₄²⁻—, and MnO₄⁻/MnO₄²⁻ may be investigated as potential cathode materials. FIG. 6 shows the energies relative to Li⁺/Li⁰ of various redox couples dissolved in water when converted from the electrochemical potentials vs. standard hydrogen electrode (SHE) or Ag⁺/Ag⁰. It is noted that the electrochemical window of water was restricted to the voltage range of 3.0 V-4.2 V vs. Li⁺/Li⁰ (0.0 to 1.2 V vs. SHE) due to the decomposition of water as can be seen in the following reactions during discharge and charge:

Li⁺+H₂0+e⁻→LiOH+½H₂:3.0 V at discharge

LiOH→Li⁺+e⁻+½H₂O+¼O₂:4.2 V at charge

However, it is likely possible to achieve higher voltages by accessing the redox couples in the non-aqueous solvents such as acetonitrile (AN), sulfolane (TMS), nitro methane (NM), and propylene carbonate (PC) because their oxidation potentials reach up to 6.0 V vs. Li⁺/Lio (in case of AN). The electrochemical potentials of Fe³⁺/Fe²⁺ and Cu²⁺/Cu⁺ in acetonitrile are 1.44 V and 0.69 V, respectively, vs. Ag⁺/Ag⁰, which can be converted to 5.2 V and 4.5 vs. Li⁺/Li⁰. The copper redox couple in a mixture of acetonitrile/water solvent is higher than it is in pure water, indicating the effect of solvents on redox potential. These examples show that like Li solid solutions, the voltage of the Li liquid solutions may be tuned by changing the combination of the host chemistry, host structure, and selection of transition metal redox couples. Many types of liquid solutions 110 may be selected for various Li-Liquid battery systems 5 for different types of electric energy storage applications.

Among many candidates for use in a Li-Liquid flow battery system 5 effective for a large energy storage device, the present technology typically includes liquid cathodes 25 that satisfy high potential vs. Li⁺/Li⁰, low cost, reliable safety, environmentally friendly chemistry, good reversibility, and lack of side reaction. The use of water as the cathode 25 in the flow mode battery system 5 may be a candidate because it is plentiful, safe, and has an environmentally friendly chemistry. Moreover, the voltage efficiency may be improved by modifying the water chemistry by addition of solutes. In addition to liquid cathodes 25, to make the Li-Liquid flow battery 10 more efficient, the Li-ion conducting solid electrolyte 40 is necessary. The presently used solid electrolytes 40 are based on NASICON-type structure of ceramics such as Li_{1.3}Ti_{1.7}Al_{0.3}(PO₄)₃. Their ionic conductivities (10⁻³-10⁻⁴ S/cm2) are less than that of organic liquid electrolytes (˜10⁻² S/cm2) 35, which limit the powder density of the battery 10. In addition, the ceramic electrolytes are not stable in strong acid or basic liquid solutions. However, when using presently available solid electrolytes 40, the low current rate Li-Liquid flow battery 10 may be developed. The pH character of the liquid cathodes 25 can also be controlled by supplying the active liquid cathodes 25 with more neutral liquids.

The voltage of the liquid solution cathodes 25 may be tuned by changing the chemical components of the liquid solutions including the solvent, additive, redox couple, and counter anion. When using water as the cathode 25, the discharge voltage of the water changes when different types of chemicals, including gas, liquid, and solid phases, are dissolved: 3.0 V for argon gas, 2.4 V for nitrogen gas, 3.0 V for acetonitrile, 2.8 V for table salt, and 2.4 V for sugar. In the case of redox couples dissolved in liquid solutions 110, the discharge voltages of Cu(NO₃)₂ in water, Cu(CIO₄)₂ in water, and Cu(CIO₄)₂ in the mixed solvent of acetonitrile and water, are observed to be 3.1 V, 3.5 V, and 3.9 V, respectively, vs. Li⁺/Li⁰. This indicates that the voltage of the copper redox couples changes with different counter anions in the same solvent (water) and with the same counter anion (CIO₄⁻) using different solvents (mixture of acetonitrile and water). The selection of liquid solutions and testing them as cathodes 25 for the Li-Liquid flow mode battery system 5 leads to a large capacity, low cost, environmentally friendly device, which could be applied to a stationary energy storage system.

In the present novel technology, a multi-layer electrolyte 35 is typically used. The multi-layer electrolyte 35 consists of at least one liquid electrolyte layer 37 and at least one solid electrolyte layer 40. The liquid electrolyte 37 is typically an organic liquid and is used because, as a liquid, it provides good physical contact with the solid Li in the anode side 30. The solid electrolyte 40 is typically an inorganic solid that, as a solid, separates the two liquids (liquid electrolyte and liquid cathode), which prevents them from mixing while also making it possible to use a cathode in all three phases (solid, liquid, and gas).

LiPF₆ in EC:DEC (1:1) liquid electrolyte 37 is used with a Li metal anode 30. In order to prevent the liquid cathode 25 and electrolyte 37 from mixing, the open side of a polyethylene bar containing the Li metal anode 30 and the LiPF₆ liquid electrolyte 37 is sealed from the cathode compartment 27 by a dense ceramic solid electrolyte 40. The solid electrolyte 40 is Li_{1.3}Ti_{I.7}Al_{0.3}(PO₄)₃ with a 1 inch×1 inch area, 150/lm thickness, and σ_{LI}˜10⁻⁴ S/cm at room temperature. The sealing of the anode part 33 by the solid electrolyte 40 is typically done to protect the Li metal anode 30 from exposure to a highly oxidizing cathode environment. A relatively low Li-ion conductivity of the solid electrolyte 40 can limit the electrochemical performance of the liquid cathode 25 when a high current discharge or charge is applied.

By using a solid electrolyte 40 with a lower HOMO in the cathode side 27 there is greater flexibility in choosing cathodes 25 that produce voltages above 4.5 V. This is an improvement over the small electrochemical window of liquid electrolytes 35. In addition, when the anode part 33 of the cell 10 composed of Li metal 30 and the organic liquid electrolyte 37 are separated and sealed by the dense solid electrolyte 40 the choices for cathode 25 are dramatically widened to include solid, liquid, and gas phases. This electrolyte strategy can also be used to collect Li metal from waste Li-ion batteries containing Li-ion sources including the LiₓC₆ anode, the LiₓCoO₂ cathode, and the LiPF₆ in the EC:DEC electrolyte materials.

Water may be used as the cathode 25 with Li metal as the anode 30. Water is discharged at 3.0 V by the formation of H₂ gas, and is charged at 4.2 V by the evolution of O₂ gas. The amount of water cathode 25 is decreased by losing H₂ and O₂ gas during each cycling. However, if water is provided continuously into the flow mode system 5 as shown in FIG. 1, water may be selected for the liquid cathode 25 for the Li-Liquid flow battery 10 for energy storage devices because it is abundant, inexpensive (free in most places), and environmentally friendly. In addition, the voltage efficiency of the water cathode 25 can be improved by the use of catalysts and dissoluble additives. When platinum is used as a catalyst on the carbon paper 55, the charge voltage drops to 3.5 V, and the discharge voltage slightly increases to 2.6 V, which results in a 74% voltage efficiency. Although the platinum is not cost effective for a large energy storage application, this result shows that the voltage efficiency of water can be improved by the use of catalysts. The addition of different types of solutes into water 25 may also affect the discharge and charge voltage of the water cathode 25. It is also well known in the electrolysis of salt water that the chorine (Cl) gas is released rather than oxygen (O₂) gas at the anode electrode even though a comparison of the standard reduction potentials indicates that O₂ gas should form first rather than Cl gas under ideal conditions. It is apparent that if salt water is used as the cathode in the battery flow mode system there is not only an improvement in the voltage efficiency of the water but also in the production of Cl gas and NaOH during the charge of the battery (collecting Li metal). The system 5 may be used as a large energy storage device and may be also be used as the factory that produces Cl, NaOH, and H₂ materials.

The discharge voltage of the water 25 is also affected by the gas phases dissolved in the water cathode 25. Water cathodes 25 bubbled with argon and nitrogen gases produce a different voltage: 3.0 V for argon gas and 2.4 V for nitrogen gas compared with 2.6 V for pure DI water that dissolves oxygen gas. The initial high discharge voltage at 3.1 V for pure water is due to the reaction of Li-ions with oxygen inside the water.

In some embodiments, the electrochemical performance of water as a liquid cathode 25 may be improved by using different solutes because water is inexpensive, abundant, and environmentally friendly. The voltage of the Li-Water battery 10 is influenced by the presence of gas, liquid, or solid phases dissolved in water. The different chemistry of the solutes may contribute to the thermodynamic activity of water by changing intramolecular and intermolecular hydrogen bonds in water resulting in different voltage behaviors of the water.

Harvesting Li Metal from Waste Li-Ion Battery Materials

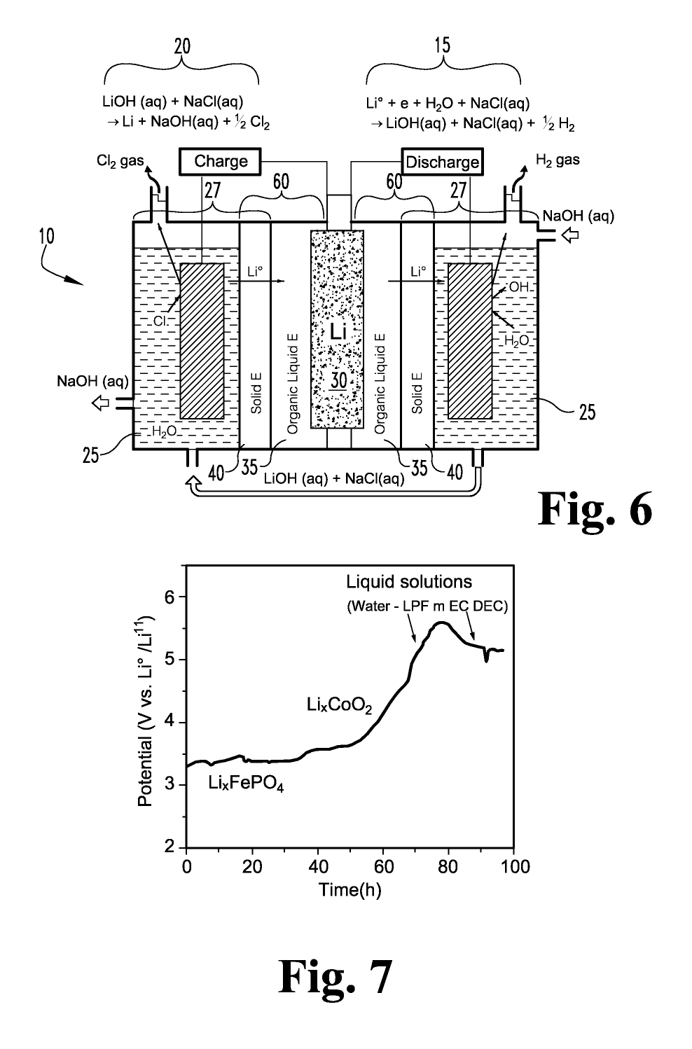

The multilayer electrolyte strategy may also allow for the collection of Li metal from the waste battery materials that contain Li-ion sources, such as the LiₓC₆ anode 80, the LiₓCoO₂ cathode 25, and the LiPF₆ in the EC:DEC liquid electrolyte 35. The waste Li-ion battery 85 may be disassembled and then anode 80 and cathode 25 electrodes, separator, and organic liquid electrolytes 35 may be inserted in water and stirred to collect electrode powders, electrolytes, and the like, that contain Li-ions. After removing the current collector 197 and separator, only the liquid solution 110 that contains electrode powders 195 and liquid electrolytes 35 remain. These Li-ion sources may be placed in carbon paper 55 in the cathode part 25 and charged with a bare stainless steel or like electrode 100 (instead of using a Li metal electrode). FIG. 7 shows the charge voltage curves of the liquid solution 110 that contain LiₓC₆, LiₓFePO₄, LiₓCoO₂, and organic liquid electrolyte 35 in combination. The voltage curves corresponding to Li extraction from LiₓFePO₄, LiₓCoO₂, and liquid solutions 110 are shown. However, the voltage curve related to Li extraction from LiₓC₆ is not observed. This is likely because LiₓC₆ is a very reducing agent, thus it reacted with the water directly instead of with the materials inside the water. This result demonstrates that the Li metal may be recycled from waste Li-ion battery materials 50 that include solid and liquid materials. Since this proposed process is simple, it would be cost effective and could easily be adopted in the charge system of the Li-Liquid flow battery 10 shown in FIG. 1. This approach may be attractive because Li metal resources are becoming scarcer while waste Li-ion batteries 85 may increase in number from the high consumption of Li-ion batteries.

Redox Couples and their Voltage Dependence on Solvents and Counter Anion

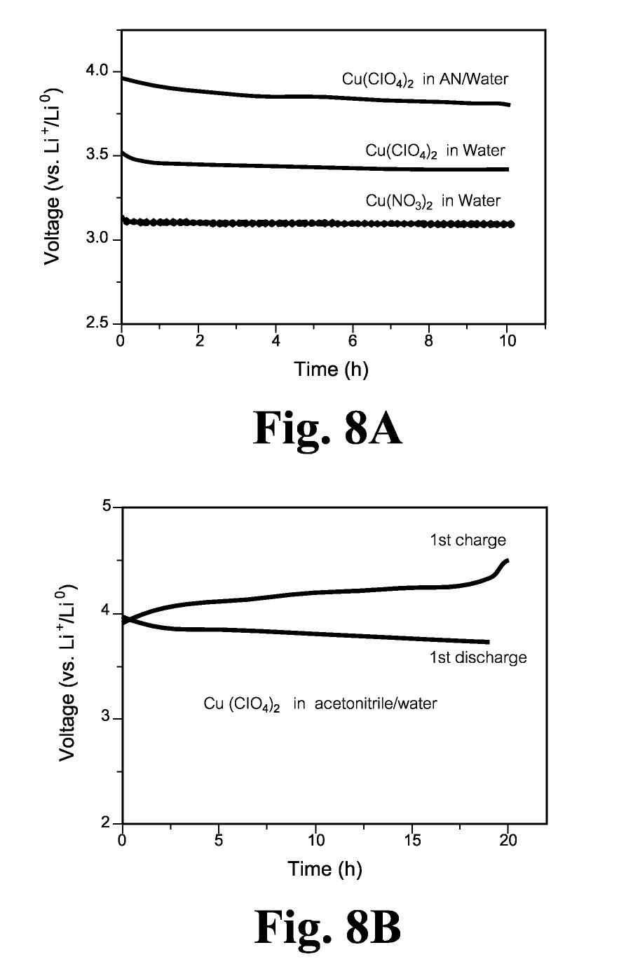

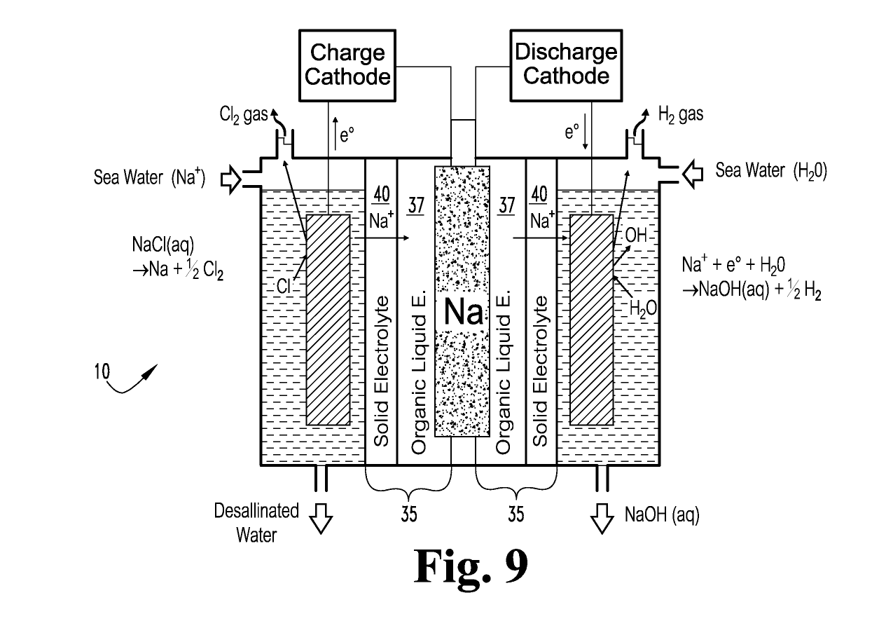

In one embodiment, transition metal redox couples dissolved in liquid solutions are possible liquid cathodes 25. Two solvents, water and acetonitrile (AN), may be used to dissolve hydrous Cu(NO₃)₂.2.5H₂O and Cu(CIO₄)₂.6H₂O to prepare at least three types of liquid solutions: Cu(NO₃)₂ in water, Cu(CIO₄)₂ in water, and Cu(CIO₄)₂ in acetonitrile/water mixture, and the like. The discharge voltages of the samples are observed to be 3.1 V vs. Li⁺/Li⁰ for Cu(NO₃)₂ in water, respectively, as shown in FIGS. 8A-8B. The expected chemical reaction at each discharge can be summarized as following:

2Li⁺+Cu(NO₃)₂(aq)+2e⁻→2LiNO₃(aq)+Cu(s) in water:3.1 V

2Li⁺+Cu(CIO₄)₂(aq)+2e⁻→2LiClO₄(aq)+Cu(s) in water:3.5 V

2Li⁺+Cu(CIO₄)₂(aq)+2e⁻→2LiClO₄(aq)+Cu(s) in AN/water:3.9V

-OR-

Li⁺+Cu(CIO₄)₂(aq)+e⁻→LiClO₄(aq)+Cu(CIO₄)(aq) in AN/water

The 0.4 V difference in Cu(NO₃)₂ and Cu(CIO₄)₂ in water is due to the use of different counter anions, (NO₃)⁻ and (CIO₄)⁻. The interaction of the anions with Li ions and the hydrogen bonding in the water solvent are the causes for the voltage difference.

While the counter anion may affect the voltage of the cathode 25, the choice of solvent at least partially does as well. 4.5 V vs. Li⁺/Li⁰ may be achieved by dissolving the Cu2+/Cu+ redox couple in pure AN. In addition to voltages vs. Li⁺/Li⁰, the voltage and coulombic efficiency (the voltage and capacitance ratio of discharge to charge) of the Cu(CIO₄)₂ in acetonitrile/water is measured by discharging the cell for 20 hours, followed by charging it for 20 hours. The average voltage and Coulombic efficiency is −91% and −100%, respectively, during first discharging and charging of the cell. The voltage and Coulombic efficiency may be enhanced by optimizing the mole concentration of Cu(CIO₄)₂ in solvent and cell components.

In some embodiments, the Li-Liquid battery system 5 may have high storage efficiency without using cell components similar to those required for the prior art Li-ion battery systems.

The multilayer electrolyte 35 allows for the exploration of many types of liquid solutions for cathodes 25 for the Li-Liquid battery system 5. The electrochemical performance of liquid cathodes 25 may be tuned by varying the combination of the solvent, the solute, the redox couple, and the counter anion. These observations point to many potential candidates for liquid cathodes 25 for use in a Li-Liquid flow battery system 5. The relatively low Li-ion conductivity of the solid electrolyte 40 limits the power density of the battery 10 and its chemical stability with liquid solutions limits a long cycle life of the battery as well as safety.

### Liquid Material Synthesis

Liquid solutions with aqueous, non-aqueous, and mixed solvents may be prepared. Water dissolving different types of solutes also referred to as additives are prepared by placing or bubbling in the case of gas phases the solutes, in water. The gas phases include helium, neon, argon, and nitrogen and the like. The liquid phases include acetonitrile, acetone, ethanol, methanol, and other dipole liquids that may be dissolved in water. The solid phases include strong electrolytes such as NaCI, NaBr, and NaI and weak electrolytes such as sucrose.

Aqueous solutions that contain copper and iron redox couples may be conveniently repaired by dissolving hydrated salts such as Cu(NO₃)₂, Cu(CIO₄)₂, Fe(NO₃)₃, and Fe(CIO₄)₃ in water. Other types of salts such as CuCl, Cu₂(SO₄)₂, FeCl₃, FeBr₃, and Fe₂(SO₄)₃ may be dissolved in water to witness the effect of the counter anion on the redox potential in water. Because metal salts easily hydrate, it is difficult to prepare phase pure and anhydrous non-aqueous liquid solutions. The methods described herein are adapted and modified to synthesize redox couples in other anhydrous non-aqueous solvents such as sulfolane (TMS) and propylene carbonate (PC). If it is not possible to prepare a pure non-aqueous solution, the mixed solvent such as the mixture of water and acetonitrile are prepared, and the effect of solvent on redox potential and redox reaction mechanisms are observed by adding acetonitrile into water. Other redox couples such as CO₃⁺/CO₂⁺ and Ni³⁺/Ni²⁺ redox couples can also be explored.

The samples described above may be placed in the multi-layer battery cell 10 as shown in FIG. 1. The voltage efficiency of water can be improved by dissolving NaCI in the water. In addition, the inexpensive, environmentally friendly NaCl/water liquid solution can be used to produce Cl and NaOH in the Li-Liquid flow battery system. In some embodiments, the safety of the cell 10 is tested by intentionally creating direct contact between the anode 30, which consists of Li metal and the organic liquid electrolyte 35, and the cathode side 25, which consists of the liquid solution 110. Li metal may form a passive film 120 when exposed to alkaline aqueous solutions, which may reduce the thermodynamic activity of the Li metal in the liquid 35. The stability of the film 120 may be improved by placing minor liquid and solid additives 123 such as methanol (CH₃OH), sucrose (C₁₂H₂₂O₁₁), and gallium oxide (Ga₂O₃), and the like. The additives 123 may improve the passive film formed on the surface 46 of the Li metal. The use of chemical additives or solutes 123 may improve the voltage efficiency of the water cathode 25.

Typically, the temperature resulting from the mixing of the anode 30 and cathode 25 is carefully measured to detect the magnitude of heat released during a certain amount of time, and the test is performed with the various liquid cathodes including aqueous, non-aqueous, mixed solvents, and the like. The characterization of the film formed on the surface of the Li metal may be performed by using SEM, TEM, Raman, and impedance spectroscopy.

### Group I Metal (Li) Harvesting

In some embodiments, Li metal may be recycled from waste Li-ion battery materials 50 by using waste solid electrode 80 and liquid electrolyte 35 materials that have been placed in water. The solid electrode powders 195 such as LiₓFePO₄, LiₓCoO₂, LiₓMn₂O₄, and LiₓNi_{0.5}Mn_{1.5}O₄, and the like do not readily dissolve in water, so the current collector 197 in the charge system of the Li-Liquid flow battery 10 may be designed to provide reliable contact with the solid powders 195. In addition, the design may also allow the solid powders 195 to move out from the current collector 197 after charging the battery 10 so that the charging portion 20 may receive new waste powders 195 from the liquid tank containing waste battery materials 50. As a current collector 197 carbon paper with a mean pore size of 30 or the like may be used. The addition of functionalized carbon powders or the like in the water may be used since such carbon powders or the like have a good dispersion character in water. This approach may improve the charge efficiency of the battery 10 by providing better electronic conductivity between waste materials 50 in water. An organic liquid electrolyte 35 and graphite anode 80 containing Li ions may change phases when they are placed in water. However, Li-ions may be separated from the Li compounds in all the phases by the charging process and become Li metal in the anode 30.

The inorganic solid electrolytes 40 may have compositions based on Li_{1.3}Ti_{1.7}Al_{0.3}(P0₄)₃, but may be at least slightly modified by performing a minor chemical substitution to improve mechanical and chemical strength as well as Li-ion conductivity. However, Li-ion conductivity, about 1⁰⁻⁴ S/cm, is still not competitive to that of an organic liquid electrolyte 35, about 10⁻² S/cm. In addition, the Li_{1.3}Ti_{1.7}Al_{0.3}(P0₄)₃-based solid electrolytes 40 may slowly decay when exposed to strong acid or basic liquid solutions. It is also known that this type of solid electrolyte 40 containing Ti⁴⁺ is not stable when in direct contact with Li metal anode 30 because the Ti⁴⁺ is reduced to Ti⁺ by the Li metal. In some embodiments a garnet type solid electrolyte 40, Li₇La₃Zr₂O₁₂, having Li-ion conductivity up to 10₋₃ S/cm, good stability against Li meta 45 l, and a wide electrochemical window (0-7 V vs.Li+/Li⁰) is used. A sulfide or like thin film may be applied on the surface of the Li_{1.3}Ti_{1.7}Al_{0.3}(PO₄)₃ solid electrolyte. In another embodiment, a sulfide film, which has Li-ion conductivity approximately to 10⁻² S/cm and is stable with Li metal, is formed on the anode portion 33 of the present solid electrolyte 40. The cathode portion 27 of the solid electrolyte 40 may be coated with chemically stable compounds such as a lithium phosphorus oxynitride (LiPON) or the like to improve the chemical stability of the solid electrolyte 40 in strong acidic or basic liquid solutions.

The novel Li-Liquid flow battery 10 may have a discharge portion 15 and charge portion 20, which allows the battery 10 to discharge and charge simultaneously and to improve the capacity and voltage efficiency. Through the system 5, the components of the discharge portion 15 may be modified and developed to consider improving the discharge properties of the liquid solutions 110. The components of the charge section 20 may maximize the charge character of the liquid solutions 110.

In some embodiments, the components in the anode portion 130 and cathode portion 125 may include current collectors 197, a catalyst, the surface of the solid electrolyte 40, the additives, and the flow rate.

### Example 1

Group I metal, sodium in particular, may be collected from seawater electrochemically at room temperature by using an electrochemical device such as a battery 10 or the like, and the collected Na metal 120 in the battery cell 10 may be discharged by using the water in the seawater as the cathode 25. Thus, a Na-seawater flow battery 10 for an energy storage system 5, where the discharge portion 15 and charge portions 20 are separated to facilitate the use of seawater as both electrodes 25, 30 for the battery 10, may be safely and efficiently produced. In the charging portion 20, the seawater flows into the charging section 20 in which Nations dissolved in seawater may be transferred into the anode portion by charging the system. If the system 20 is charged by using a renewable energy system the renewable energy may be stored by the formation of Na metal in the anode 30. As for the discharging system 15, the seawater will flow into the discharging section 15 where the H₂O the seawater can be used as the cathode 25 completing the circuit and providing electric energy. In this way, the seawater can be both anode 30 and cathode electrodes 25 in the flow battery 10. Additionally, by-products such as desalinated water and Cl₂ gas can be obtained by charging seawater meaning this battery 10 may operate as a seawater desalination device in an alternate embodiment. When the battery 10 discharges the seawater, H₂ gas and NaOH may be obtained as the by-products.

Seawater contains 96.5% water, 1.08% sodium, and various weight percentages of other chemicals such as chlorine (1.89%), magnesium (0.13%), and so on. Thus, by charging an electrochemical device 5, Na-ions dissolved in seawater may be transferred through an Na-ion exchange membrane and collected by forming Na metal on an current collector 55 in the anode side 33. This collected Na metal 120 may be discharged with the water in seawater to produce electric energy. Seawater flows into the charge portion 20 where the sodium in the seawater may be collected and stored in the anode 30 by charging the cell 10.

Na⁺(seawater)+Cl⁻(seawater)→Na+Cl₂

Seawater flows into the discharge section 15 in which water in seawater reacts with Na-ions from the anode 30 to produce electric power with the voltage of 2.7V vs. Na⁺/Na⁰ according to Standard Electrode Potentials Table.

Na⁺+e⁻+H₂O(seawater)→NaOH+½H₂

The battery system 10 operates by using Na metal as the anode 30 and H₂O as the cathode 25 with the seawater providing both electrodes.

The multi-layer electrolyte 35 consists of one liquid electrolyte 37 and one solid electrolyte 40. Any Na-ion conducting organic liquid that is stable with Na metal can be used as the liquid electrolyte 37. As a liquid, the electrolyte 37 creates close physical contact with the solid electrolyte 40 and the current collection portion where the Na metal will form during charging of the battery 10. The fast Na-ion conducting solids may be used as the solid electrolyte 40 that separates the two liquids of the liquid electrolyte 37 and the seawater liquid cathode 25 which may prevent the two liquids from mixing but also allows only Na-ions to pass between the two liquids 25, 37.

If the Na-ion conductivity in the solid electrolyte 40 materials reaches about σNa>10⁻⁴ S/cm at room temperature, the battery system 10 built on the solid electrolyte 40 may operate at room temperature with applying a low current rate (˜0.1 mA/cm²).

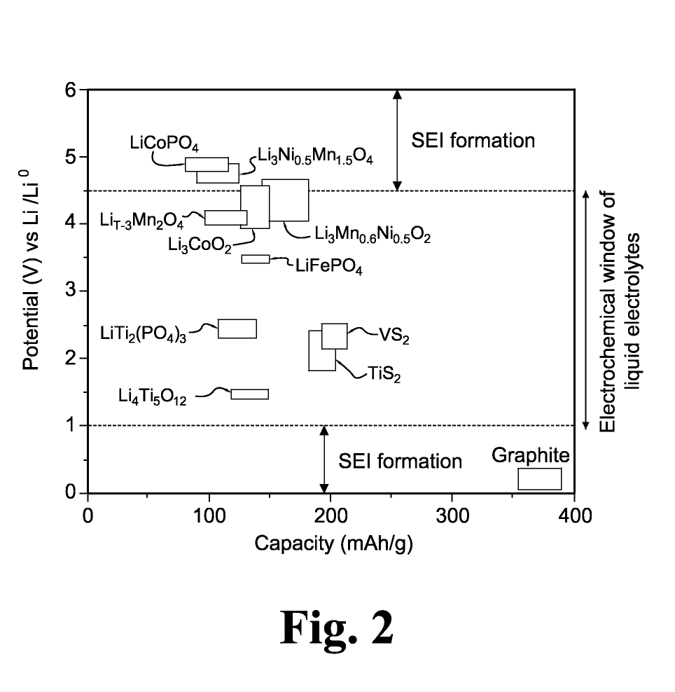

The liquid solution 110 is placed on carbon paper 55 in the cathode portion 27 as shown in FIG. 2 and charged with a bare stainless steel (SS) electrode 100 instead of using a Li metal electrode 30. The pure liquid electrolyte 37 1M LiPF6 in EC:DMC is oxidized at 5.3 V vs. Li⁺/Li⁰ at the current rate of 0.1 mA/cm² where Li-ions are transferred into the anode portion 33 and form Li metal. A 0.1M LiOH aqueous liquid solution is prepared and charged. The flat charge voltage curve appeared at 4.0 V with the chemical reaction below:

4LiOH(aq)→4Li(s)+2H₂O(l)+O₂(g)

When the organic liquid electrolyte 37 (1 M LiPF6 in EC:DMC) is mixed with water in a volume ratio of 1:1, the charge voltage curve is at approximately 3.7V vs. Li⁺/Li⁰ at 0.1 mA/cm². This charge voltage is significantly lower than the 5.3V of the pure liquid electrolyte 37. Since the redox reaction in the liquid solution 110 is affected by the chemistry of the solvents and salts, the new chemical compounds formed in the mixed liquid solution is likely responsible for the low charge voltage of 3.7 V. The liquid solutions containing Li-ions were charged at length. Li metal 120 is observed on the surface of the SS electrode 100 after disassembling the cell 10. An aggressive exothermal reaction occurs when the SS electrode 100 is placed in the water, which further confirms the formation of Li metal 120.

Additionally the formation of Li metal on the SS electrode 100, the charged cell 197 which collects Li metal from waste battery materials 55 is discharged when pure DI water is used as the cathode 25. FIG. 5D shows the discharge voltage curve of the pure DI water versus Li metal harvested from the waste batteries. The mean discharge voltage is approximately 2.7 V vs. Li⁺/Li⁰ at 0.1 mA/cm², which is similar to the voltage found when fresh Li metal is used in the cell. The following chemical reaction occurs during discharge of the Li-water cell 10.

2Li(s)+2H₂O(l)→2LiOH(aq)+H₂(g)

The discharged products are LiOH dissolved in water and H₂ gas. The LiOH (aq) may be used as the cathode 25. However, a high concentration (>1M) of LiOH (aq) may damage the solid electrolyte 40 due to its strong basic character.

In the Li-liquid flow battery system 5, the discharged product of LiOH (aq) may flow into the other side (charge section) of the battery system 5 and may be charged to recycle the Li ions contained in it. In this way, the concentration of LiOH may be kept low during cycling of the cell 10 by circulating the liquid solution 110.

In another embodiment, the Na-ion multilayer electrolyte 35 is used, the Na may be collected from the sea water, and the collected Na may be used as the anode 30 in the seawater.

In one embodiment, the cell 10 may rely on the electrochemical performance of seawater as both electrodes. As shown in FIG. 8, instead of a lithium solid electrolyte 40 a Na-ion conducting ceramic plate, such as a sodium β″-Al₂O₃ ceramic plate having an ionic conductivity is σNa=2*10⁻³ S/cm at room temperature, may be used as the solid electrolyte 40. The rectangular sodium β″-Al₂O₃ ceramic plate, measuring 20 mm by 20 mm by 1 mm is used as the solid electrolyte 40 for this embodiment. Sodium salt (NaClO₄) and non-aqueous solvents such as ethylene carbonate (EC) and diethyl carbonate (DEC) are mixed to prepare 1M NaClO₄ in EC:DEC (1:1 volume ratio) for the liquid electrolyte 37 in the anode portion 30. However, since the Na metal is a greater reducing agent than the organic liquid electrolyte 37 the chemical compositions of the organic liquid electrolytes 37 may be modified to provide better stability with Na metal by the formation of a suitable solid-electrolyte interface (SEI) layer. The anode portion 30 of the cell 10 containing the organic liquid electrolyte 37 is sealed with the solid electrolyte ceramic plate 40 to prevent the organic liquid 37 from mixing with seawater. A chemical epoxy that is stable with both the organic liquid electrolyte 37 and the seawater may be used as the sealing agent between the Na β″-Al₂O₃ ceramic plate and the anode portion 30 of the cell 10 made of polyethylene. The carbon paper in the cathode side may be used as the current collector 55 for the seawater cathode 25.

The dependence of the electrochemical performance of the seawater on its chemical composition and concentration is verified by using the battery cell 10 described above. Seawater is be placed in the cell 10 and may be charged at desired voltages where Na-ions transfer into the anode side 33 from seawater. Except for the H₂O, the major chemical compound in the seawater is the NaCl, with a salinity of between 3.1% and 3.8%. However, the mole concentration of NaCl in seawater differs depending on the places where mixing occurs. Fresh water runoff from river mouths containing less NaCl and areas of water where high rates of evaporation occur containing more NaCl. Hence, the effects of NaCl concentration and the salt water's other chemical components (see Table 1) on charge voltage may be verified.

TABLE 1
Total molar composition of seawater (salinity = 3.5%)

| | | | | | | | | | | |
|---|---|---|---|---|---|---|---|---|---|---|
| Component | H₂O | Na⁺ | Cl⁻ | Mg²⁺ | 2− | 2 | + | − | 2+ | F⁻ |
| Concentration | 53.6 | 0.46 | 0.546 | 0.0528 | 0.0282 | 0.0103 | 0.0102 | 0.00084 | 0.00009 | 0.00006 |

First, 0.5 mole of the NaCl may be dissolved in the pure DI water and may be used as the sample for measuring the charge voltage of transferring Na-ions from the water into the anode side. Then, the voltage behaviors of the liquid solutions with the addition of other chemicals such as Mg²⁺, Ca²⁺, and Br⁻ may be systematically measured. In addition, the higher and lower concentration of NaCl in the salt water may be prepared, and their effects on voltage may be investigated.

Upon discharging of the cell 10, the voltage effects of the NaCl concentration and other minerals in the seawater may be measured versus Na metal. Then, the collected Na may also be used as the anode 30 and compared with the fresh Na metal. The purity of the collected Na metal may be determined such as by the chemical analysis technique of the energy dispersed X-ray (EDX) in a scanning electron microscope (SEM).

The charge and discharge performance of the cell 10 is typically accomplished at the low current rate of 0.1 mA/cm² but may also be done at a higher current rate.

The cell 10 may be designed so that it operates at a temperature higher than 100° C. At a higher operating temperature, higher power can be achieved by increasing the Na-ion conductivity through the solid electrolyte 40. In addition, the Na metal melts at temperatures above 100° C. and thus has a good retention with the solid electrolyte 40, eliminating the need to use the organic liquid electrolyte 37 in the anode side 30. However, the seawater in the cathode side 25 may vaporize at temperatures over 100° C. Since the vaporazition temperature of water increases at higher pressures (Tᵥₐₚ=100° C. at 1 bar, Tᵥₐₚ=180° C. at 10 bar), the cathode portion 25 of the cell 10 may be designed to maintain the seawater at high pressure so that it will remain in liquid phase at the increased operating temperature.

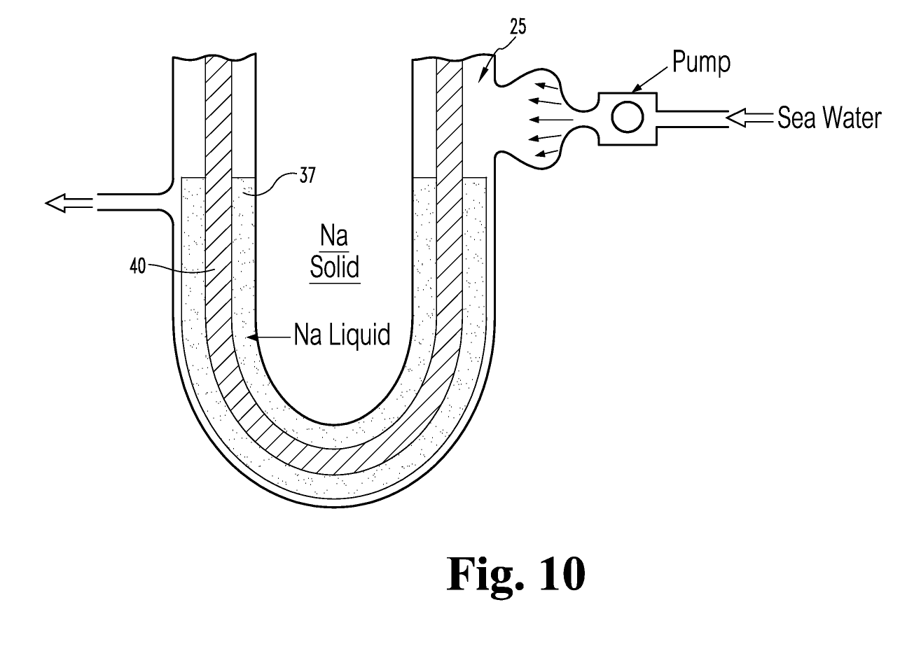

FIG. 10 shows the schematic diagram of another embodiment electrochemical cell 10. The U shape of the sodium β″-Al₂O₃ ceramic plate may be used as the solid electrolyte 40. Heating elements 24 made of carbon, graphite, or metal sponge (or foam) may be loaded inside and outside of the solid electrolyte tube 40.

This heating element 24 increases the temperature of the solid electrolyte 40 and protects it by working as a buffer layer. In addition, when the heating element 24 is porous enough molten Na metal liquid electrolyte 37 and/or seawater m a y flow through the heating elements 24, which provide more surface area where electrochemical reactions occur. Moreover, since Na-ions can be intercalated into the carbon and graphite materials the heating elements 24 may work as the anode 30 as well.

In the cathode side 25, the seawater is pumped into the narrow area outside of the solid electrolyte 40 typically experiencing high pressure while flowing through the porous heating element 24. At a pressure higher than 10 bar (1 MPa), the vaporation temperature of water may be higher than 180° C., thus allowing the seawater to remain in a liquid state at 150° C. The bending strength of the Na beta solid electrolyte is 250-300 MPa and the fracture toughness is 2-3 (MPa m^{1/2}). Different operating temperatures and pressures may be used.

In the above design, the power may be increased. However, additional energy is needed to actuate the heating element 24. With a Na-ion conducting solid electrolyte 40 producing a satisfactory electrochemical performance at suitably lower temperatures, the Na-Seawater battery system 10 can function without using part of its energy to increase the heat.

### Example 2

Instead of the Li solid electrolyte 40, a Na-ion conducting sodium β″-Al₂O₃ ceramic plate having an ionic conductivity of σ_{Na}=2×10⁻³ S/cm at room temperature was used as the solid electrolyte 40. Sodium salt (NaClO₄) and non-aqueous solvents such as ethylene carbonate (EC) and diethyl carbonate (DEC) was mixed to prepare 1M NaClO₄ in EC:DEC (1:1 volume ratio) to create the liquid electrolyte 37 on the anode side 33. The anode portion 33 of the SSS flow battery cell 10 containing the electrode 30 and organic liquid electrolyte 37 was sealed with the solid electrolyte ceramic plate 40 to prevent the organic liquid 37 from mixing with the seawater. The cell resistance increased because of using the multilayer electrolyte 35, but this was minimized by using a thin solid electrolyte 40 and by using a thin liquid electrolyte 37 volume. To keep the cell 10 acting reversibly a low current rate of 0.1 mA/cm² was applied, which is sufficient for harvesting Na metal 120 from seawater and discharging using the H₂O from seawater to produce electric energy.

Except for H₂O, seawater consists mainly of NaCl (see Table 2). However, the molar concentration of NaCl in seawater differs depending on the source of the seawater, for example, fresh water runoff from river mouths or areas of glacial ice melts containing less NaCl or areas of water where high rates of evaporation occur leaving behind a higher concentration of NaCl in the seawater. The effects of the NaCl concentration and the seawater's other chemical components (see Table 2) on voltage, current, and cell operation is investigated. The seawater is placed in the charge portion 20 and the charge voltage that corresponds to Na-ion extraction from the seawater is measured. In a separate discharge portion 15, the discharge voltage of the seawater versus Na metal is measured. The charge and discharge performance of the cell 10 is initially tested at the low current rate of 0.1 mA/cm², but is also tested at higher (and lower) current rates to more fully characterize the performance of the SSS flow battery.

TABLE 2
Total molar composition of seawater (salinity = 3.5%)

| | | | | | | | | | | |
|---|---|---|---|---|---|---|---|---|---|---|
| Component | H₂O | Na⁺ | Cl⁻ | Mg²⁺ | SO₄²⁻ | Cat²⁺ | K⁺ | Br⁻ | Sr²⁺ | F⁻ |
| Concentration | 53.6 | 0.469 | 0.546 | 0.0528 | 0.0282 | 0.0103 | 0.0102 | 0.000844 | 0.000091 | 0.000068 |
| (mol/kg) | | | | | | | | | | |

The SSS flow battery 10 has separate charge and discharge cathode sections 15, 20 which allow the battery to charge and discharge separately. By keeping the charge and discharge sections 15, 20 separate in the system 5, the components of each section 15, 20 may be independently modified and developed to separately optimize performance of each respective section 15, 20. Materials for the cell components including Na-ion conducting solid and liquid electrolytes 40, 37, current collectors 55, sealing epoxy, and cell body materials is tested with seawater to find stable cell component materials that produce repeatable electrochemical performance data.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A Group I metal electrochemical cell, comprising:
a cathode chamber;
an anode chamber;
a solid electrolyte separating the cathode chamber and the anode chamber;
a carbon paper portion disposed in the cathode chamber;
a liquid cathode portion disposed in the cathode chamber;
a group I metal anode portion disposed in the anode chamber;
an organic liquid electrolyte portion disposed in the anode chamber;
a first electrode connected in electric communication with the cathode chamber; and
a second electrode connected in electric communication with the anode chamber.

2. The cell of claim 1, wherein anode chamber includes a metal anode portion selected from the group including lithium, sodium, potassium, rubidium, cesium and francium.

3. The cell of claim 1 wherein the cathode chamber includes a first cathode chamber portion and a second, spaced cathode chamber portion; and wherein the anode chamber is disposed between the first and second cathode chamber portions.

4. A Group I metal electrochemical cell, comprising:
a first cathode chamber;
a second, spaced cathode chamber;
an anode chamber disposed between the first and second cathode chambers and in electrochemical contact therewith;
a first solid electrolyte separating the first cathode chamber and the anode chamber;
a second solid electrolyte separating the second cathode chamber and the anode chamber;
a first current collector portion disposed in the first cathode chamber;
a second current collector portion disposed in the second cathode chamber;
a respective liquid cathode portion disposed in each respective cathode chamber;
a Group I metal anode portion disposed in the anode chamber;
an organic liquid electrolyte portion disposed in the anode chamber;
a first electrode connected in electric communication with the first cathode chamber;
a second electrode connected in electric communication with the second cathode chamber; and
a third electrode connected in electric communication with the anode chamber.

5. The electrochemical cell of claim 4, wherein the Group I metal anode portion is selected from the group including lithium, sodium, potassium, rubidium, cesium, and francium.

6. A method of harvesting Group I metal, comprising:
a) preparing an electrochemical cell, the electrochemical cell further comprising:
a cathode chamber;
an anode chamber in electric communication with the cathode chamber;
a Group I metal anode portion disposed in the anode chamber;
a solid electrolyte separating the cathode chamber and the anode chamber;
a carbon paper portion disposed in the cathode chamber;
an organic liquid electrolyte portion disposed in the anode chamber;
a first electrode connected in electric communication with the cathode chamber; and
a second, non-Group I metal metallic electrode connected in electric communication with the anode chamber;
b) at least partially filling the cathode chamber with a liquid solution containing lithium;
c) applying a voltage across the first and second electrodes; and
d) collecting Group I metal on the second electrode.

7. The method of claim 6, wherein the Group I metal anode portion is selected from the group including lithium, sodium, potassium, rubidium, cesium and francium.

8. An energy storage system, comprising:
a housing;
a seawater sourced cathode assembly having a first charging portion and a second, spaced discharging portion substantially disposed within the housing;
a seawater sourced anode assembly substantially disposed within the housing and disposed between the first charging portion and the second, spaced discharging portion; and
a multilayer electrolyte disposed between the charged cathode portion and discharged cathode portions;
wherein the multilayer electrolyte includes at least one solid layer and at least one liquid layer in electric communication with each other;
wherein the seawater sourced anode assembly is in electronic communication with the seawater sourced cathode assembly; and
wherein Group I ions derived from a seawater source are transferred from the seawater sourced cathode section to the seawater sourced anode section.

9. The energy storage system of claim 8, wherein the Group I ions are selected from the group including lithium, sodium, potassium, rubidium, cesium, and francium.

10. The energy storage system of claim 8 wherein the charging portion includes a first inlet port for flowing seawater thereinto, a first gas outlet port for discharging chloring gas, and a first liquid outlet port for discharging desalinated water.

11. The energy storage system of claim 8 wherein the discharging portion includes a second inlet port for flowing seawater thereinto, a second gas outlet port for discharging hydrogen gas, and a second fluid outlet port for discharging aqueous sodium hydroxide solution.

12. A method of harvesting Group I metals from waste materials, comprising:
a) agitating Group I metal-containing materials in water to define a Group I metal-rich aqueous solution;
b) removing any solid material from the Group I metal-rich aqueous solution;
c) filling the cathode portion of an electrochemical cell with the Group I metal-rich aqueous solution;
d) introducing a current collector into the Group I metal-rich aqueous solution;
e) operationally connecting a steel electrode to the cathode portion; and
f) operating the cathode portion to deposite Group I metal onto the steel electrode.

13. The method of claim 12 and further comprising:
g) collecting Group I metal from the steel electrode.

14. The method of claim 12 wherein the Group I metal is lithium.
